(19) United States
(12) Patent Application Publication
(10) Pub. No.: US 2009/0319440 A1
(43) Pub. Date: Dec. 24, 2009

(54) SYSTEM AND METHOD FOR PROVIDING RETIREMENT PLAN HEALTH REPORTS

(75) Inventors: J. William Montgomery, Lakeville, MN (US); Rhiannon Rial, Mississauga (CA); Daisy Lew, Toronto (CA); Edward Eng, Toronto (CA)

Correspondence Address: ROPES & GRAY LLP, PATENT DOCKETING 39/41, ONE INTERNATIONAL PLACE, BOSTON, MA, 02110-2624, US

(73) Assignee: John Hancock Life Insurance Company (U.S.A.), Boston, MA (US)

(21) Appl. No.: 12/419,789

(22) Filed: Apr. 7, 2009

Related U.S. Application Data
(60) Provisional application No. 61/123,300, filed on Apr. 7, 2008.

(51) Int. Cl. G06Q 40/00

(52) U.S. Cl. 705/36 R

(57) ABSTRACT

The invention relates, in various aspects, to systems and methods for providing a current status of a retirement plan of an employer. A server receives a report request transmitted from a client operated by a user. In response to the report request, the server generates a plan health report including the current status of the retirement plan based on employee information related to the retirement plan. The current status of the retirement plan includes information indicating retirement readiness of employees of the employer. The server transmits the plan health report for receipt by the client. The employee information related to the retirement plan is stored in a database.

### CROSS-RELATED APPLICATION

This application claims the benefit of U.S. Provisional Application Ser. No. 61/123,300, filed Apr. 7, 2008, the entire contents of which are incorporated herein by reference.

### BACKGROUND OF THE INVENTION

One of the main sources of retirement income for many individuals is employer-provided retirement plans. The retirement income from many of such plans depends on the amount of money contributed pre-retirement by the employee and employer and on the rate of return enjoyed by the contributions. In particular, an employee who participates in an employer-provided retirement plan defers a portion of his salary to his retirement plan account, which accrues returns over time. His employer may contribute an amount as well under a company matching program, where the amount contributed by the employer depends on the amount contributed by the employee. Once the employee retires, he may withdraw income from the account balance. It is desirable for post-retirement income to be a substantial fraction of pre-retirement income for each employee, so that employees can better maintain the lifestyle, and concomitant expenses, that they have become accustomed to.

Contributions to retirement plans are typically made over a long period of time, such as 30 to 40 years. Given this long time horizon, many employees underestimate the appropriate deferral amount necessary to achieve a desirable retirement income, namely one that is sufficiently close to their pre-retirement income. Employers, brokers of retirement plans, and/or third party administrators of retirement plans may be interested in improving the retirement readiness of employees eligible for a retirement plan. Such interested parties may improve retirement readiness, for example, by encouraging participation in the plan, suggesting deferral increases, or offering different retirement plans to better suit employee preferences. To that end, it would be useful to provide such interested parties with information conveying the current status of a retirement plan, where the current status allows one to gauge the success and/or utilization of a retirement plan. As such, a need remains in the art for systems and methods for providing plan health reports that include the current status of a retirement plan. A need also remains for systems and methods for providing reports that indicate the overall retirement readiness of employees.

### SUMMARY OF THE INVENTION

Accordingly, in one aspect, the invention relates to a system for providing a current status of a retirement plan of an employer. The system includes a server and a database. The server receives a report request transmitted from a client operated by a user, generates a plan health report in response to the report request, and transmits the plan health report for receipt by the client. The plan health report includes the current status of the retirement plan based on employee information related to the retirement plan. The current status of the retirement plan includes information indicating retirement readiness of employees of the employer. The database stores the employee information related to the retirement plan. In some embodiments, the server includes a proxy server and an application server, where the proxy server receives the report request and transmits the plan health report and the application server generates the plan health report.

In some embodiments, the employees are organized into groups according to the employee information and the plan health report indicates the current status of the retirement plan according to the groups. In some implementations, the employee information includes age information indicating an age of at least one employee of the employer and the plan health report indicates the current status of the retirement plan for a plurality of age ranges. The plurality of age ranges may include 29 and under, 30-39, 40-49, 50-59, or 60 and over. The plan health report may indicate retirement readiness of employees of a selected age range.

In some embodiments, the server generates an average deferral rate of the retirement plan and the plan health report includes the average deferral rate and a comparable national average deferral rate. In some embodiments, the server generates an average participation rate of the retirement plan and the plan health report includes the average participation rate and a comparable national average participation rate.

In some embodiments, the report request indicates a request for individual reports and the server generates an individual report including information indicating retirement readiness of an individual employee of the employer.

In some embodiments, the employee information includes, for each employee of the employer participating in the retirement plan, a deferral rate, an income, and a retirement plan account balance for the respective employee. In some embodiments, the employee information includes, for each employee of the employer, an indication of whether the respective employee is eligible for the retirement plan.

In some embodiments, the retirement readiness indicated in the plan health report is determined based on a predetermined retirement age, inflation rate, and life expectancy. In some embodiments, the retirement readiness indicated in the plan health report includes a percentage of employees not meeting a retirement target. In some embodiments, the retirement readiness indicated in the plan health report includes a percentage of employees exceeding a retirement target.

In some embodiments, the report request includes a spreadsheet of employee information related to the retirement plan, and the current status of the retirement plan is based on the employee information in the spreadsheet. In some embodiments, the report request comprises at least one of a target replacement pay level, a rate of return of the retirement plan, and a company match representing contributions of the employer to retirement plan accounts.

In another aspect, the invention relates to a method for providing a current status of a retirement plan of an employer. The method includes the steps of receiving at a server a report request transmitted from a client operated by a user, generating a plan health report in response to receiving the report request, and transmitting the plan health report for receipt by the client. The plan health report includes the current status of the retirement plan based on employee information related to the retirement plan. The current status of the retirement plan includes information indicating retirement readiness of employees of the employer. The method also includes the step of storing the employee information related to the retirement plan in a database.

### BRIEF DESCRIPTION OF THE DRAWINGS

The invention may be better understood from the following illustrative description with reference to the following drawings.

FIG. 1 is a block diagram of an illustrative system for providing a current status of a retirement plan of an employer, according to one aspect of the invention.

FIG. 2 is a block diagram of an illustrative system for providing a current status of a retirement plan of an employer, according to one aspect of the invention.

FIG. 3 is a block diagram of a computer architecture suitable for implementing various computing devices incorporated into the systems of FIGS. 1 and 2.

FIG. 4 is a portion of an exemplary spreadsheet of employee information related to a retirement plan of an employer, according to one aspect of the invention.

FIGS. 5-9 depict exemplary screenshots from a website for providing plan health reports, according to one aspect of the invention.

FIGS. 10A and 10B depict exemplary pages of a plan health report, according to one aspect of the invention.

FIG. 11 is a flowchart of an illustrative method for providing a current status of a retirement plan of an employer, according to one aspect of the invention.

FIG. 12 is a flowchart of an illustrative method for providing a plan health report of a retirement plan of an employer, according to one aspect of the invention.

### DESCRIPTION OF CERTAIN ILLUSTRATIVE EMBODIMENTS

To provide an overall understanding of the invention, certain illustrative embodiments will now be described. However, it will be understood by one of ordinary skill in the art that the methods and systems described herein may be adapted and modified as is appropriate for the application being addressed and that the systems and methods described herein may be employed in other suitable applications, and that such other additions and modifications will not depart from the scope thereof.

The systems and methods described below apply to any group retirement plan whose individual account balances depend on contributions to the account and the rate of return enjoyed on the account balances. Exemplary retirement plans include Individual Retirement Accounts (IRAs), 401(k) plans, and 403(b) plans.

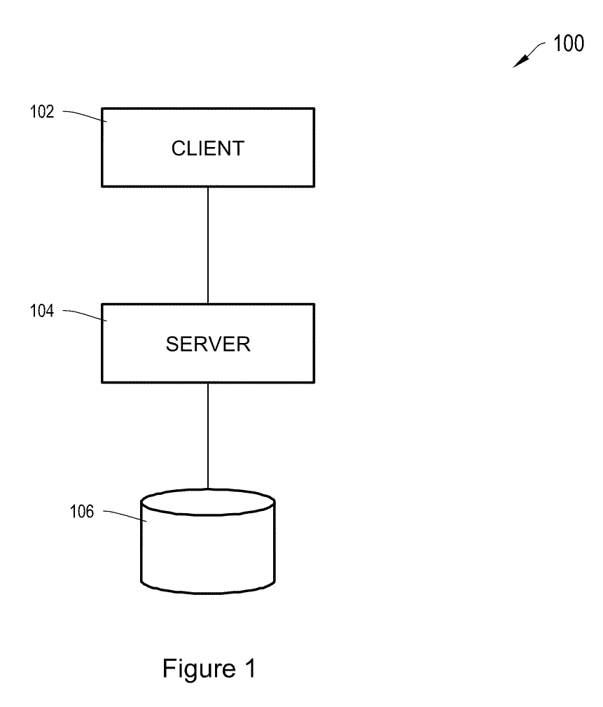

FIG. 1 is a block diagram of an illustrative system 100 for providing a current status of a retirement plan of an employer, according to one aspect of the invention. System 100 includes a client system 102, a server 104, and a database 106, which communicate with one another over one or a combination of communication networks. Communication networks used by the systems described herein may be wired, wireless, or a combination thereof. They may be publicly accessible, such as the Internet, or part of a private communication network. Preferably, at least portions of communications over the communication networks are encrypted to protect the privacy of customers.

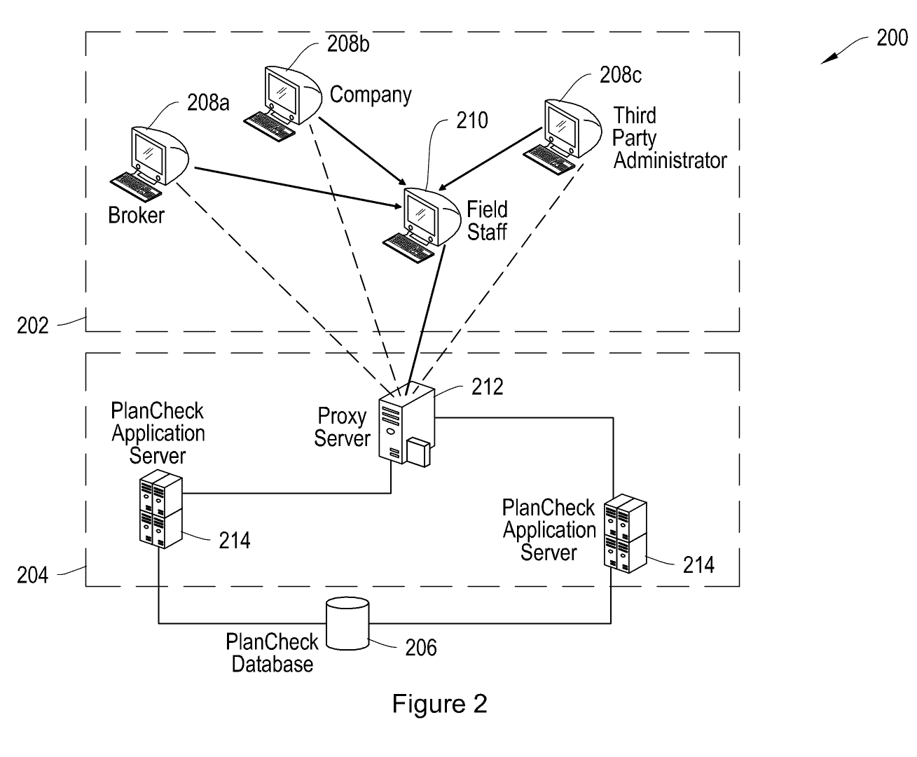

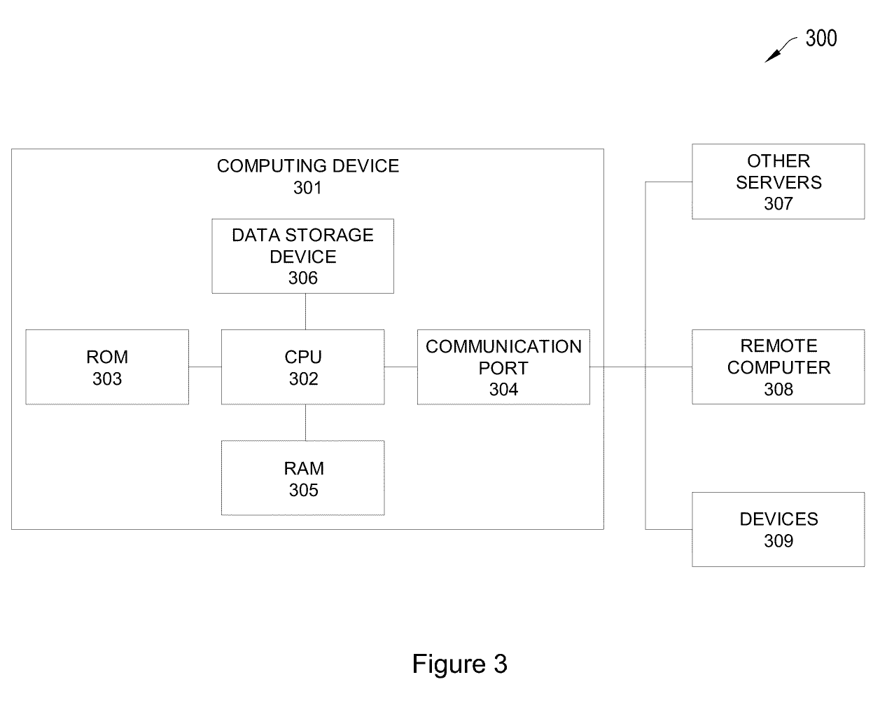

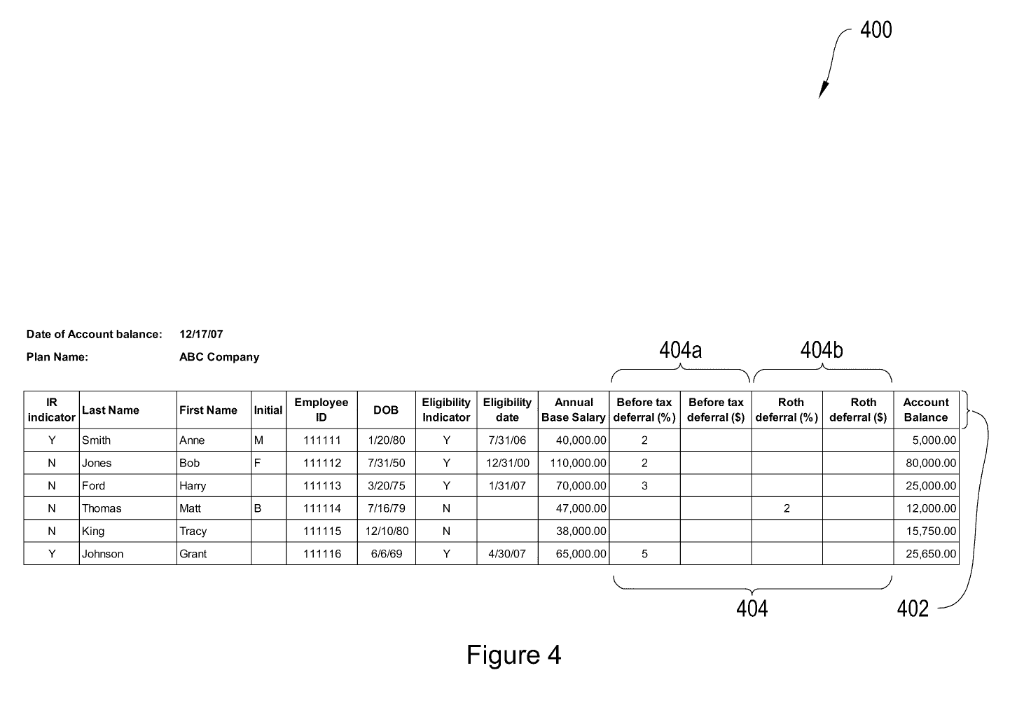

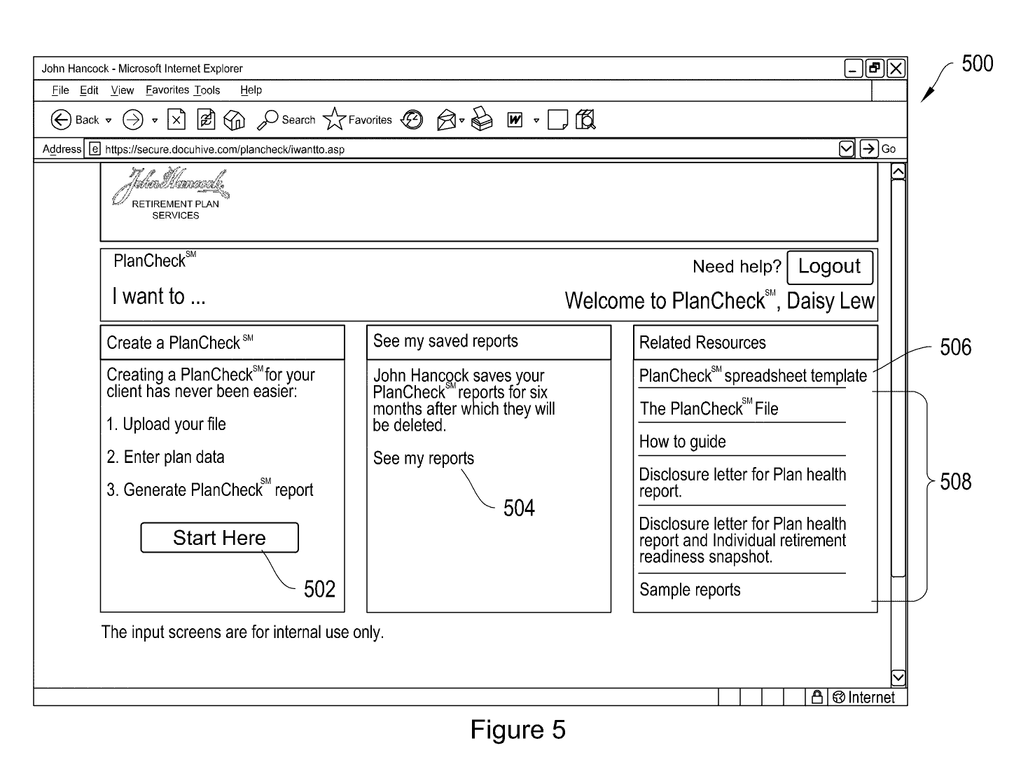

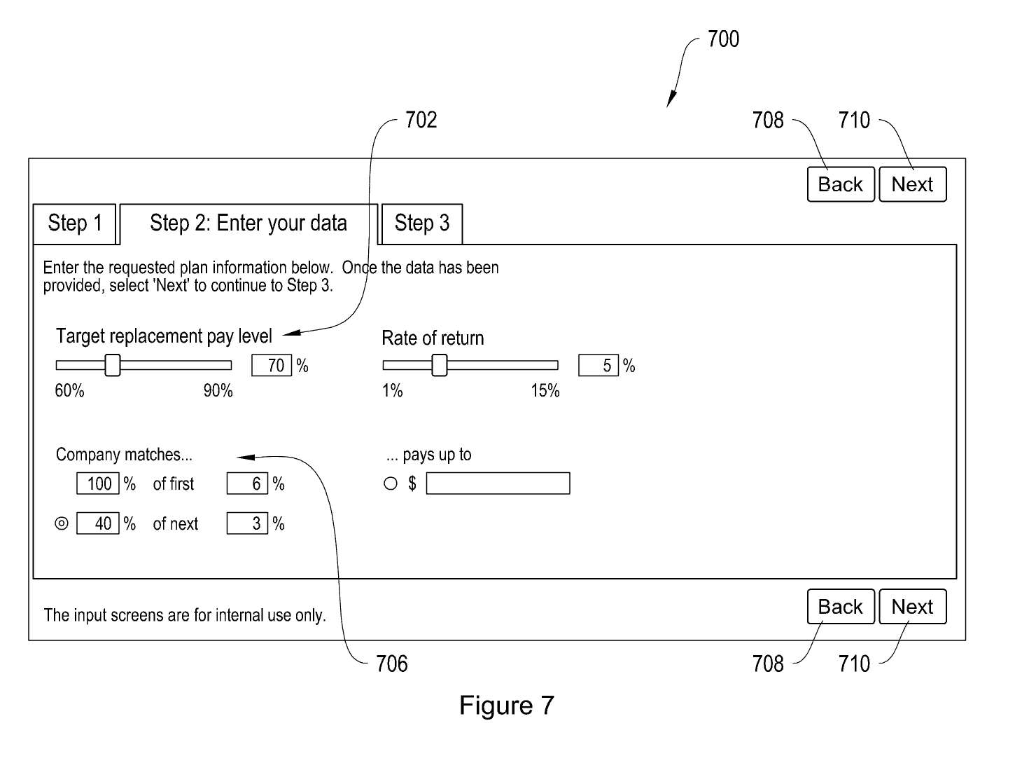

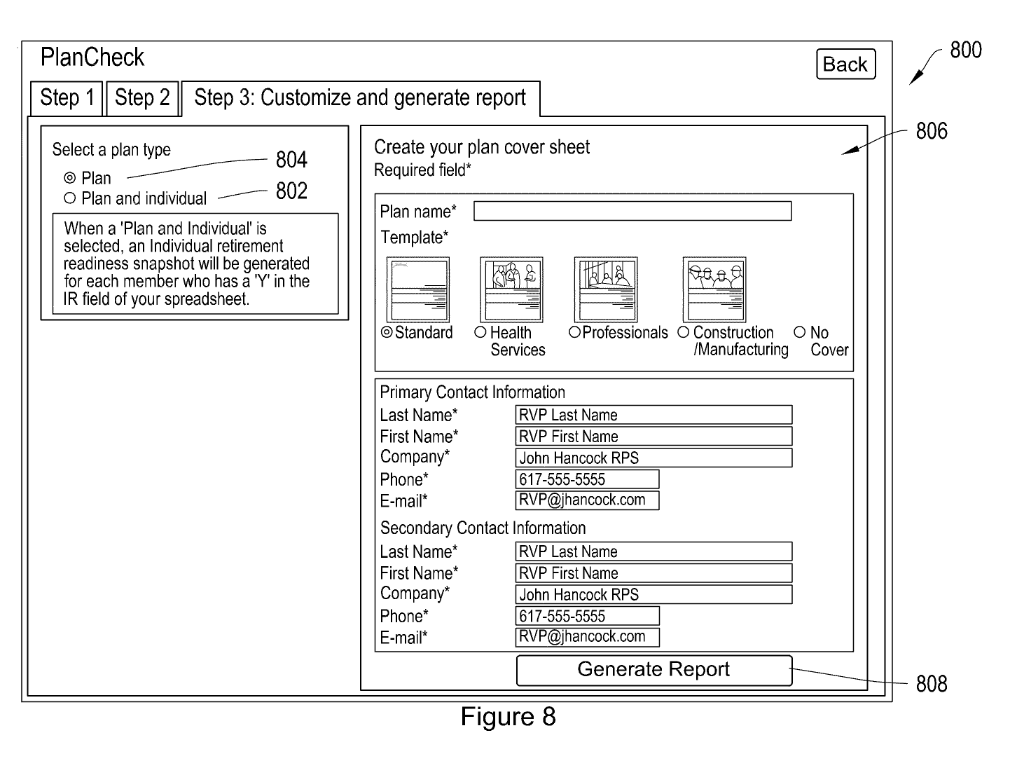

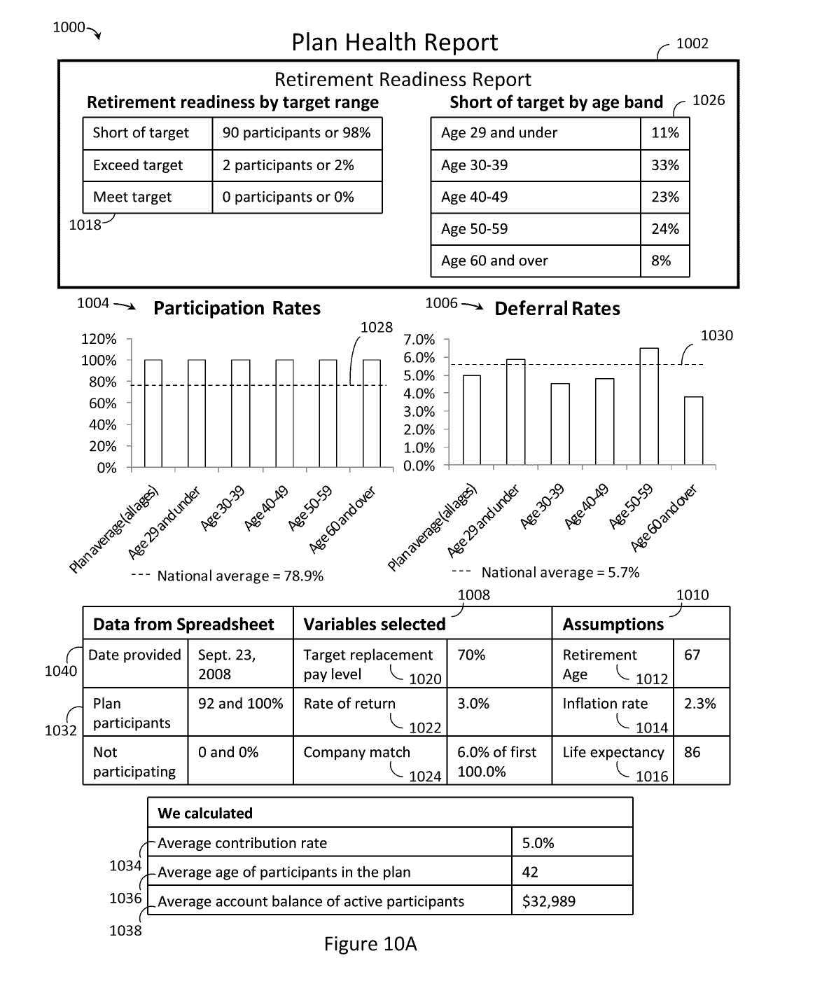

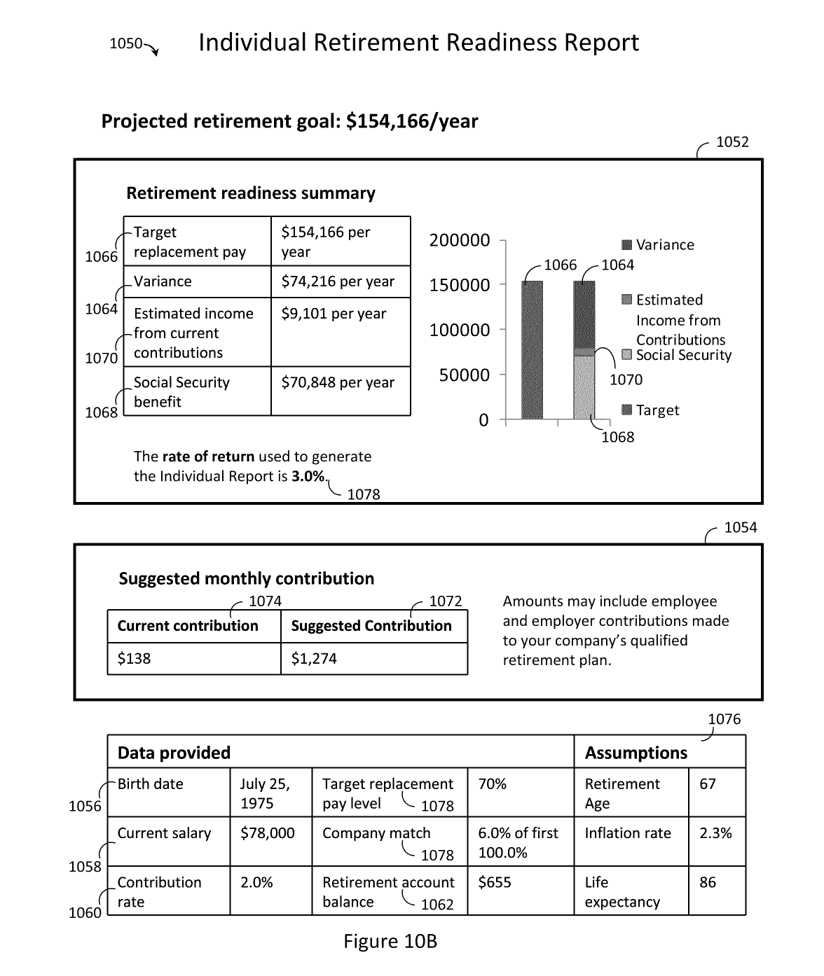

Client system 102 includes one or more user computers, described further below with respect to FIGS. 2 and 3. The user computers allow a user to interface with system 100 to request and receive a plan health report including the current status of a retirement plan of an employer. In some embodiments, the current status of the retirement plan includes information indicating retirement readiness of employees of the employer who are eligible for the retirement plan. In some embodiments, a report request transmitted by client system 102 includes a spreadsheet of employee information related to the retirement plan, such as the spreadsheet depicted in FIG. 4. In some embodiments, a report request acts to retrieve a plan health report that has already been generated. In some embodiments, a report request includes information specifying parameters related to a retirement plan, such as target replacement pay level, rate of return, or company matching parameters, for use in calculating data to be included in the report. In some embodiments, a report request indicates whether the report should include individual reports, each related to retirement readiness of individual employees of the employer. Exemplary screenshots that may be displayed to users via client system 102, for allowing a user to initiate a report request, are described below with respect to FIGS. 5-9. Plan health reports received by client system 102, such as those described below with respect to FIGS. 10A and 10B, can be viewed by users or transmitted to other systems, such as other user computers.

Server 104, described further below with respect to FIGS. 2 and 3, receives report requests transmitted by client system 102 and, in response, generates the plan health report based on employee information stored in database 106 or retrieves the desired plan health report from database 106. In particular, server 104 performs calculations to determine data to be included in a report, where the calculations use information received in the report request and/or stored in database 106. Server 104 transmits the plan health report for receipt by the client system 102. In some embodiments, any employee information received in the report request is stored in database 106 and used to generate the plan health report. Exemplary calculations that may be performed by server 104 in generating the plan health report are described below with respect to FIG. 2. Database 106 is described further below with respect to FIGS. 2 and 3.

FIG. 2 is a block diagram of an illustrative system 200 for providing a current status of a retirement plan of an employer, according to one aspect of the invention. System 200 includes client systems 202, servers 204, and databases 206, which may be similar to client system 102, server 104, and database 106, respectively, of FIG. 1.

Client system 202 includes field staff system 210 operated by a user affiliated with a provider of a service that offers evaluations of employer retirement plans, such as via the plan health reports described herein. The field staff system 210 communicates over one or a combination of communication networks with other systems, such as broker system 208a, company system 208b, and third party administrator system 208c, to exchange information related to a retirement plan. Broker system 208a is operated by a broker who sells retirement plan products to employers. Company system 208b is operated by a user affiliated with an employer offering a retirement plan to its employees. Third party administrator system 208c is operated by a user affiliated with an entity that manages a retirement plan for an employer. In some embodiments, systems 208 transmit to field staff system 210 information, such as employee information related to the retirement plan whose current status is desired, with which a user of field staff system 210 initiates a report request for transmittal to server 204. In some embodiments, the field staff system 210 transmits a set of fields to a system 208, where each field describes a type of information to be provided by a user of system 208, and the system 208 transmits the requested information organized according to field for some or all employees of an employer. Exemplary types of information are described below with respect to FIG. 4. In addition or alternatively, report requests are initiated by any of systems 208a, 208b, or 208c.

Server 204 includes proxy server 212 and one or more application servers 214. Proxy server 212 receives requests from systems 208 and/or 210 and directs the requests among application servers 214 for processing. Exemplary requests include report requests, requests for websites via which report requests may be initiated, and requests for reports that have already been generated and have been stored in database 206. After application server 214 generates a response to a request, proxy server 212 transmits the response, such as a requested website or plan health report, for receipt by the requesting system. Application server 214 includes a processor for calculating data to be included in a plan health report and for generating the plan health report in a format for conveying the calculated data to a user of client system 202. Application server 214 performs calculations using data stored in database 206. In some embodiments, data stored in database 206 includes data received by the application server 214, via proxy server 212, from client system 202. In some embodiments, plan health reports generated by application server 214 are stored in database 206. Exemplary reports and calculations are described below with respect to FIGS. 10A and 10B. In some embodiments, application server 214 provides a website via which report requests may be initiated. Exemplary screenshots of such a website are described below with respect to FIGS. 5-9. In some embodiments, application server 214 provides a website via which already generated reports may be retrieved.

FIG. 3 is a block diagram of a computer architecture 300 suitable for implementing various computing devices 301 incorporated into the systems 100 and 200, including, for example, the application servers 214.

Computing device 301 comprises at least one central processing unit (CPU) 302, at least one read-only memory (ROM) 303, at least one communication port or hub 304, at least one random access memory (RAM) 305, and one or more databases or data storage devices 306. All of these later elements are in communication with the CPU 302 to facilitate the operation of the computing device 301. The computing device 301 may be configured in many different ways. For example, computing device 301 may be a conventional standalone server computer or alternatively, the function of a server may be distributed across multiple computing systems and architectures.

Computing device 301 may be configured in a distributed architecture, wherein databases and processors are housed in separate units or locations. Some such servers perform primary processing functions and contain, at a minimum, a general controller or a processor 302, a ROM 303, and a RAM 305. In such an embodiment, each of these servers is attached to a communications hub or port 304 that serves as a primary communication link with other servers 307, client or user computers 308, and other related devices 309. The communications hub or port 304 may have minimal processing capability itself, serving primarily as a communications router. A variety of communications protocols may be part of the system, including but not limited to: Ethernet, SAP, SAS™, ATP, BLUETOOTH™, GSM and TCP/IP.

The CPU 302 comprises a processor, such as one or more conventional microprocessors and one or more supplementary co-processors such as math co-processors. The CPU 302 is in communication with the communication port 304 through which the CPU 302 communicates with other devices such as other servers 307, user terminals 308, or devices 309. The communication port 304 may include multiple communication channels for simultaneous communication with, for example, other processors, servers or client terminals. Devices in communication with each other need not be continually transmitting to each other. On the contrary, such devices need only transmit to each other as necessary, may actually refrain from exchanging data most of the time, and may require several steps to be performed to establish a communication link between the devices.

The CPU 302 is also in communication with the data storage device 306. The data storage device 306 may comprise an appropriate combination of magnetic, optical and/or semiconductor memory, and may include, for example, RAM, ROM, flash drive, an optical disc, such as a compact disc, and/or a hard disk or drive. The CPU 302 and the data storage device 306 each may be, for example, located entirely within a single computer or other computing device; or connected to each other by a communication medium, such as a USB port, serial port cable, a coaxial cable, a Ethernet type cable, a telephone line, a radio frequency transceiver or other similar wireless or wired medium or combination of the foregoing. For example, the CPU 302 may be connected to the data storage device 306 via the communication port 304.

The data storage device 306 may store, for example, (i) a program (e.g., computer program code and/or a computer program product) adapted to direct the CPU 302 in accordance with the present invention, and particularly in accordance with the processes described in detail hereinafter with regard to the CPU 302; or (ii) databases adapted to store information that may be utilized to store information required by the program. Suitable databases include database 206 of FIG. 2.

The program may be stored, for example, in a compressed, an uncompiled and/or an encrypted format, and may include computer program code. The instructions of the program may be read into a main memory of the processor from a computer-readable medium other than the data storage device 306, such as from a ROM 303 or from a RAM 305. While execution of sequences of instructions in the program causes the processor 302 to perform the process steps described herein, hard-wired circuitry may be used in place of, or in combination with, software instructions for implementation of the processes of the present invention. Thus, embodiments of the present invention are not limited to any specific combination of hardware and software.

Suitable computer program code may be provided for performing numerous functions such as calculating average deferral rates, calculating average participation rates, calculating target replacement pay for employees based on their respective current deferral practices, and calculating percentages of employees who are short of, meeting, or exceeding their target replacement pay. The program also may include program elements such as an operating system, a database management system and “device drivers” that allow the processor to interface with computer peripheral devices (e.g., a video display, a keyboard, a computer mouse, etc.).

The term “computer-readable medium” as used herein refers to any medium that provides or participates in providing instructions to the processor of the computing device (or any other processor of a device described herein) for execution. Such a medium may take many forms, including but not limited to, non-volatile media and volatile media. Non-volatile media include, for example, optical, magnetic, or opto-magnetic disks, such as memory. Volatile media include dynamic random access memory (DRAM), which typically constitutes the main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM or EEPROM (electronically erasable programmable read-only memory), a FLASH-EEPROM, any other memory chip or cartridge, or any other medium from which a computer can read.

Various forms of computer readable media may be involved in carrying one or more sequences of one or more instructions to the processor 302 (or any other processor of a device described herein) for execution. For example, the instructions may initially be borne on a magnetic disk of a remote computer 308. The remote computer 308 can load the instructions into its dynamic memory and send the instructions over an Ethernet connection, cable line, or even telephone line using a modem. A communications device 304 local to a computing device (or, e.g., a server) can receive the data on the respective communications line and place the data on a system bus for the processor. The system bus carries the data to main memory, from which the processor retrieves and executes the instructions. The instructions received by main memory may optionally be stored in memory either before or after execution by the processor. In addition, instructions may be received via a communication port as electrical, electromagnetic or optical signals, which are exemplary forms of wireless communications or data streams that carry various types of information.

As previously discussed with reference to FIG. 2, servers may also interact and/or control one or more user devices 309, such as displays and printers, or remote computers 308 such as, broker system 208a, company system 208b, third party administrator system 208c, and field staff system 210. These systems and terminals may include any one or a combination of a personal computer, a laptop, a personal digital assistant, a mouse, a keyboard, a computer display, a touch screen, LCD, voice recognition software, or other input/output devices required to implement the above functionality.

FIG. 4 is a portion of an exemplary spreadsheet 400 of employee information related to a retirement plan of an employer, according to one aspect of the invention. Spreadsheet 400 includes multiple cells arrayed in rows and columns for organizing employee information. In particular, spreadsheet 400 includes, for each employee, information corresponding to fields 402, which are related to a retirement plan of the employer. Fields 402 include: an indication of whether the employee is participating in the retirement plan (“IR indicator”), last name, first name, first initial of the middle name (“Initial”), employee identification number (“employee ID”), date of birth (“DOB”), an indication of whether the employee is eligible to participate in the retirement plan (“Eligibility indicator”), date at which employee became eligible to participate (“Eligibility date”), income data such as salary (“Annual base salary”), how much an employee has elected to defer or contribute to the retirement plan 404, and the current balance of an employee's retirement account (“Account balance”). The fields for deferral amounts 404 include an amount of pre-tax income 404a as represented by a percentage of income (“Before tax deferral (%)”) or a dollar amount (“Before tax deferral ($)”) and an amount of Roth or post-tax income 404b as represented by a percentage of income (“Roth deferral (%)”) or a dollar amount (“Roth deferral ($)”). Spreadsheets may include other fields other than those depicted in FIG. 4 or include only some of the fields of FIG. 4, where the fields may be in an order other than that depicted, without departing from the scope of the invention. Spreadsheets may include all employees of an employer or a subset of the employees whose retirement readiness the employer or another party is interested in. Spreadsheets may be transmitted on communication networks between client systems, servers, and database, in which they may be stored, to allow users of the systems to populate or edit the spreadsheet cells, as described above with respect to FIGS. 1-3. For example, a spreadsheet including fields, but no employee data, may be transmitted by field staff system 210 for receipt by one of systems 208, to allow an operator of system 208 to populate the fields with the corresponding data for a set of employees. The operator then transmits a report request, that includes the populated spreadsheet, for receipt by the proxy server 212 for processing by the application server 214. Alternatively, the operator transmits the populated spreadsheet for receipt by the field staff system 210, in which case the report request is initiated by the field staff system 210 instead of by the system 208.

FIGS. 5-9 depict exemplary screenshots from a website for providing plan health reports, according to one aspect of the invention. The website may be provided by an application server, such as application server 214 of FIG. 2, for display on a client system, such as client system 202 of FIG. 2. In some embodiments, the website requires a user to log in, provide a certificate, or otherwise indicate that the user is authorized to access features of the website, before allowing the user access to some or all of the webpages depicted herein. Exemplary reports that may be generated via the website are discussed below with respect to FIGS. 10A and 10B.

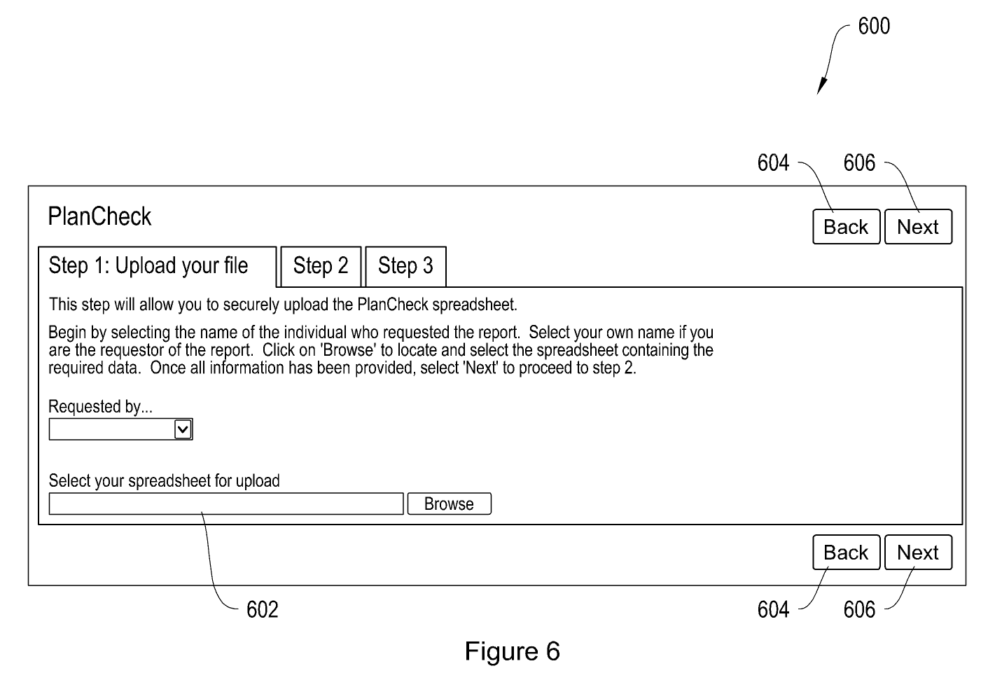

FIG. 5 depicts exemplary screenshot 500 of a homepage of the website. The user may initiate a report request by clicking “See my report” 504 or “Start Here” 502. The former allows the user to retrieve an already generated report that has been stored. The latter allows the user to provide employee information and parameters, where the report is generated based on the provided employee information and parameters. In particular, in response to the user selecting this option, the website consecutively provides three webpages, corresponding to three steps to be initiated by the user: (1) uploading a spreadsheet containing employee information related to a retirement plan, similar to spreadsheet 400 of FIG. 4; (2) entering parameters related to the retirement plan for determining the current status of the plan; and (3) generating the plan health report based on the data in the uploaded spreadsheet and the entered parameters. The three webpages are described further below with respect to FIGS. 6-8. The homepage also provides access to a spreadsheet template 506, i.e., a spreadsheet including fields of data that the website uses to generate plan health reports and cells corresponding to the fields that the user may populate, such as that described above with respect to FIG. 4. The homepage also provides access to informational resources 508 such as a guide to using the website and sample plan health reports.

FIGS. 6-8 depicts exemplary screenshots 600, 700, and 800, respectively, of webpages corresponding to the three steps described above with respect to FIG. 5. The webpage depicted in screenshot 600 is displayed in response to the user selecting “Start Here” 502 of screen shot 500. The user uploads a spreadsheet of employee information by indicating a location and name of the spreadsheet file in box 602. The previous webpage, as depicted by screenshot 500, and the webpage for the next step, as depicted by screenshot 700, may be reached by clicking on “Back” 604 and “Next” 606, respectively. The webpage depicted in screenshot 700 prompts the user to specify parameters that are to be used in calculating data to be included in the plan health report. Parameters include a target replacement pay level 702, rate of return 704, and company match 706. The target replacement pay level represents a desired post-retirement income for employees, expressed as a percentage of their current income. For example, a target replacement pay level of 70% represents a desire for post-retirement yearly income for each employee to be 70% of the respective employee's yearly income at the time of retirement. In some embodiments, the percentages that can be selected for the target range from 60% to 100%, in increments of 5%. The rate of return represents the rate of return realized on the funds contributed to the retirement plan by the employees. The company match represents parameters of a matching program offered by the employer, if one exists. In such a program, the employer contributes an amount to each employee's retirement plan account, where the employer's contribution is based on the amount contributed by the employee and the employee's salary and may be subject to a maximum dollar amount. The previous webpage, as depicted by screenshot 600, and the webpage for the next step, as depicted by screenshot 800, may be reached by clicking on “Back” 708 and “Next” 710, respectively. The webpage depicted in screenshot 800 prompts the user to specify whether the plan health report should include individual reports each indicating retirement readiness of individual employees, selected by choosing “Plan and Individual” 802, or solely include information relating to overall retirement readiness of employees, selected by choosing “Plan” 804. For example, reports similar to the individual report depicted in FIG. 10B are generated only if the user selects “Plan and Individual” 802, whereas a report similar to that depicted in FIG. 10A is generated for either selection 802 or 804. The user may also specify information 806 to be included on a cover page for the report to be generated. The report is generated in response to the user clicking on “Generate Report” 808.

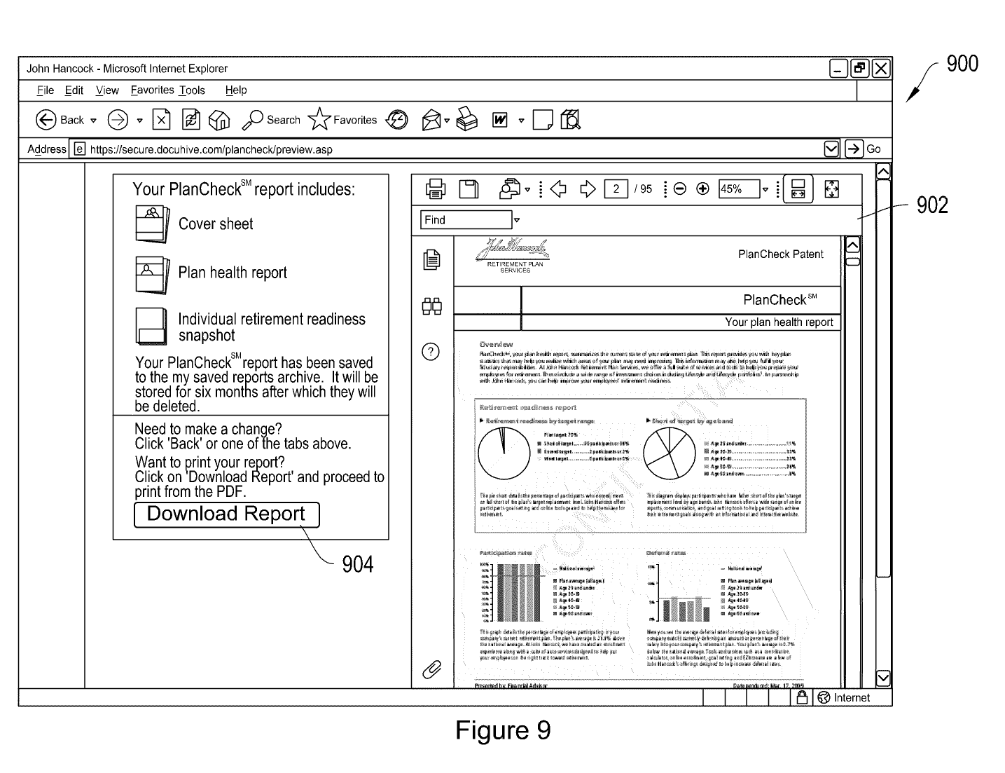

FIG. 9 depicts exemplary screenshot 900 of a webpage for previewing the generated plan health report. The user may select “Download Report” 904 to download the report to the client system being used by the user. A portion of the webpage includes an interface 902 for viewing the generated report, in case the user would like to return to earlier webpages to modify any data entered by the user before downloading. Exemplary reports that may be viewed and downloaded via the webpage depicted in screenshot 900 are described below with respect to FIGS. 10A and 10B.

FIGS. 10A and 10B depict exemplary pages 1000 and 1050, respectively of a plan health report, according to one aspect of the invention. Page 1000 is related to a current status of the retirement plan. Page 1050 depicts an exemplary individual report related to the current status of a retirement plan account of a particular employee. Page 1000 includes information related to retirement readiness 1002, participation rates 1004, and deferral rates 1006, which are calculated based on employee information related to the retirement plan, parameters 1008, and assumptions 1010 regarding relevant future events, such as retirement age 1012, inflation rate 1014, and life expectancy 1016. Retirement readiness information and participation and deferral rates may correspond to employees of a selected age range or to all employees under consideration.

Page 1000 includes a retirement readiness report 1002 for conveying whether employee account balances and current deferral practices are sufficient to achieve target replacement pay, i.e. whether they are sufficient to support post-retirement withdrawals at the target replacement pay level. In particular, the retirement readiness report 1002 indicates the percentages 1018 of participants in the retirement plan who exceed, meet, and fall short of target replacement pay, where a participant is an employee having a nonzero retirement plan account balance. Whether a participant is exceeding, meeting, or falling short of the target is determined by: (1) estimating a stream of future post-retirement withdrawals based on a target replacement pay level 1020 and a current income of the participant, assuming a particular retirement age 1012 and life expectancy 1016; and (2) estimating whether the retirement plan account balance will be sufficient to allow for such withdrawals based on the participant's current account balance, a rate of return 1022 of the plan, and any company match 1024, assuming the participant's deferral amount remains the same until retirement. The estimations may take into account an assumed rate of inflation 1014. Exemplary methods for determining whether a participant is exceeding, meeting, or falling short of target are described further below with respect to FIG. 10B.

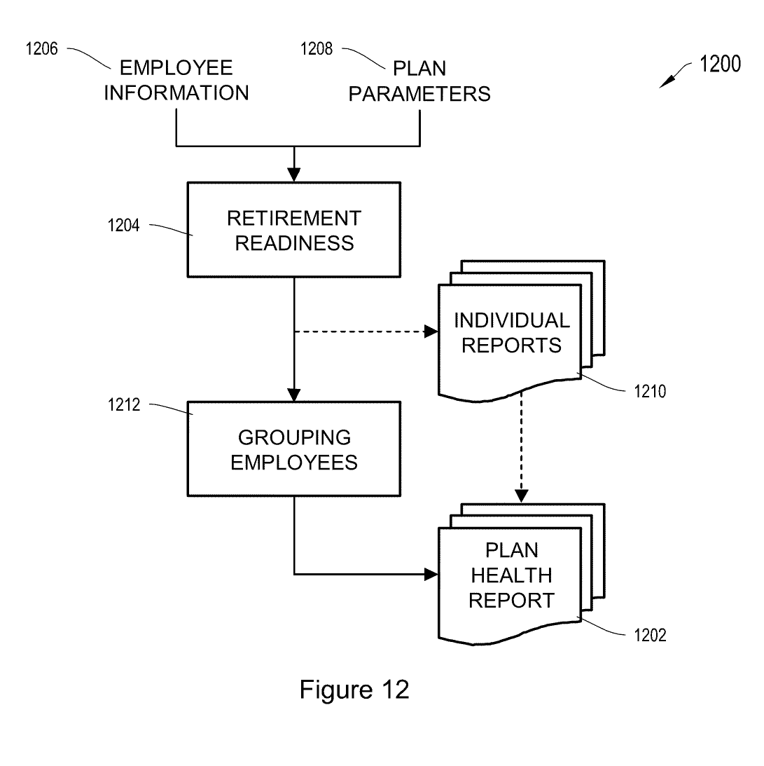

Retirement readiness of employees may be conveyed according to employee age, which can be calculated from date of birth information. For example, retirement readiness report 1002 indicates the percentages 1026 of participants falling short of target who are within selected age ranges, such as 29 and under, 30-39, 40-49, 50-59, and 60 and over. In addition or alternatively, the report may include the percentage of participants within a selected age range who are falling short of target. For example, an employer may be interested in, in addition to the overall percentage of participants ready for retirement, the percentage of participants near retirement age (e.g., 62 and over) who are ready for retirement. Additionally or alternatively, retirement readiness is conveyed according to other groupings of the employees, as described below with respect to FIG. 12.

The plan health report includes information relating to participation and deferral rates of the employees. In particular, page 1000 includes a graph 1004 of participation rates for selected age ranges. The bars on graph 1004 represent the percentage of employees within the selected age range who are participating in the retirement plan. In some embodiments, an employee is considered a participant if the employee's retirement plan account balance is nonzero. In some embodiments, an employee is considered a participant if the corresponding employee information includes data representing a deferral, such as corresponding to a field 404 of FIG. 4. In some embodiments, participation rates are a percentage of eligible employees (e.g., a percentage of the employees whose eligibility indicator indicates they are eligible to participate in the retirement plan). In some embodiments, participation rates are a percentage of employees included in a spreadsheet file, such as one similar to spreadsheet 400 of FIG. 4. In some embodiments, the graph 1004 includes a line 1028 representing a comparable average participation rate, such as a national average participation rate, to allow comparison of a participation rate of the plan to the comparable average participation rate. Similarly, page 1000 includes a graph 1006 of deferral rates for selected age ranges. In particular, each bar on graph 1006 represents the average deferral, expressed as a percentage of income, of participating employees of the selected age range. In some embodiments, the graph 1006 includes a line 1030 representing a comparable average deferral rate, such as a national average deferral rate, to allow comparison of a deferral rate of the plan to the comparable average deferral rate. The comparable average participation or deferral rate may be for a particular industry to which the employer belongs and/or for employers of a particular size. Additionally or alternatively, the comparable average participation or deferral rate may be for clients of an entity who manages, issues, or is a broker for the retirement plan. The plan health report also includes rates corresponding to all employees under consideration, such an overall participation rate 1032, which is also depicted on graph 1004, and an overall average deferral rate 1034, which is also depicted on graph 1006. Other data relating to the current status of the overall retirement plan may also be included, such as the average age of participants 1036 and the average account balance of participants 1038. The date 1040 on which the employee information was provided may also be indicated.

Page 1050 depicts an exemplary individual report related to the current status of a retirement plan account of a particular employee. In some embodiments, a plan health report includes a page similar to page 1050 for each employee who is a participant in the retirement plan. Page 1050 includes an individual retirement readiness summary 1052, a suggested deferral 1054, and employee information pertinent to the contents of the readiness report 1052 and suggested deferral 1054. Employee information includes the employee's birth date 1056, current salary 1058, deferral rate 1060 (i.e., contribution rate), and current retirement plan account balance 1062.

Individual retirement readiness summary 1052 provides a variance 1064 representing the difference between target replacement pay 1066 and estimated retirement income from both social security benefits 1068 and income 1070 from the retirement plan, estimated based on current contributions. If the variance 1064 is positive, meaning the target replacement pay 1066 is greater than estimated retirement income, the employee is falling short of target. If the variance 1064 is negative, meaning the target replacement pay 1066 is less than estimated retirement income, the employee is exceeding target. And if the variance 1064 is zero, the employee is meeting target. Target replacement pay 1066 is calculated as the product of target replacement pay level and an estimated salary at retirement for the employee. In some embodiments, the estimated salary at retirement is calculated by assuming that the employee's salary increases yearly by a specified percentage until retirement age, in which case the estimated salary at retirement is equal to:

(current salary)×(1+(percent increase in salary/100))̂(retirement age−current age),

where the current age is calculated by comparing the employee's birth date 1056 to the date on which the employee data is provided. For example, the employee corresponding to report 1050 has birth date 1056, meaning the employee is 33 years old on date 1040, leaving 34 years until retirement age 1076. Assuming the percent increase in salary each year is 3.1%, the salary at retirement is $220,236, that is the product of 1.031̂34 and current salary 1058, meaning the target replacement pay 1066 is $154,166, that is the product of the salary at retirement and the target replacement pay level of 70%. Income 1070 from the retirement plan is based on a retirement plan account balance at retirement and the expected number of years over which the employee will withdraw from the balance, namely the difference between life expectancy and retirement age. The retirement plan account balance is calculated assuming the employee continues to defer the same percentage 1060 of salary each year, the salary increases yearly as described above, the company matching program parameters 1078 remain the same until the employee's retirement, and the retirement plan account balance enjoys a constant rate of return 1078.

Suggested deferral 1054 provides a suggested deferral amount 1072, as compared to the employee's current deferral amount 1074. The suggested deferral amount 1072 is calculated such that the estimated income 1070 from the retirement plan would be sufficient for the employee's total retirement income to achieve the target 1066, i.e. for the variance 1064 to be zero. The current and suggested deferral amounts 1072 and 1074 represent monthly contributions to a retirement plan account. Alternatively, the current and suggested deferral amounts may be expressed as yearly contributions to the account.

Individual reports may also include information similar to that of page 1000. In particular, page 1050 includes assumptions 1076 regarding relevant future events, which are identical to assumptions 1010 of page 1000, and parameters 1078 such as target replacement pay level, company match, and rate of return, which are identical to parameters 1008 of page 1000.

The contents of plan health reports, and the methods and calculations for arriving at such contents, may vary from those described above with respect to FIGS. 4-10. In some embodiments, some or all of the assumptions of FIG. 10, such as retirement age, life expectancy, and inflation rates, are parameters designated by the user instead of assumptions inherent in a plan health report system. In some embodiments, some of the parameters and/or assumptions vary as opposed to remaining constant over time and over all employees. For example, whether a particular participant is falling short of target replacement pay may be based on estimating future deferrals as increasing over time and/or allowing the target replacement pay level to vary according to salary at retirement.

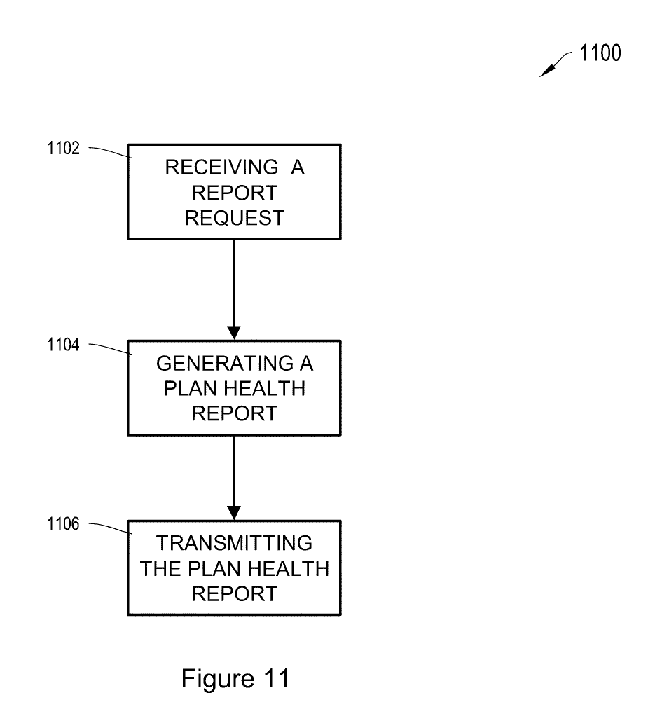

FIG. 11 is a flowchart 1100 of an illustrative method for providing a current status of a retirement plan of an employer, according to one aspect of the invention. The method includes the steps of receiving a report request 1102, generating a plan health report 1104 in response to the received report request, and transmitting the generated plan health report 1106.

The report request received at step 1102 requests a plan health report for a particular retirement plan of an employer. The report request indicates whether individual reports for each participant in the retirement plan should be included in the plan health report. In some embodiments, the report request includes parameters and/or employee information related to the retirement plan, as described above. Information included in the report request may be stored in a database, from which the information may be retrieved for processing, such as for generating plan health reports at step 1104. In some embodiments, the report request is transmitted by a client operated by a user interested in the current status of the retirement plan, as described above. For example, the report request may be initiated via a website as described above with respect to FIGS. 5-9. At step 1106, the requested plan health report is transmitted to the requesting entity, such as to the client for display to the user. In some embodiments, the report request is received by a server, such as a proxy server, via a communications network, as described above.

The plan health report is generated at step 1104. Exemplary contents of a plan health report, such as retirement readiness, participation rates, and deferral rates, and methods for calculating such contents are described above with respect to FIGS. 10A and 10B. In some embodiments, plan health reports are generated by a processor, such as a processor of an application server, as described above. In some embodiments, the plan health report includes, in addition to information relating to the overall status of a retirement plan, reports related to individual participants in the retirement plan. In some embodiments, the generated plan health report is stored in a database to allow for later retrieval.

FIG. 12 is a flowchart 1200 of an illustrative method for providing a plan health report of a retirement plan of an employer, according to one aspect of the invention. The illustrative method generates a plan health report 1202 that includes an indication of retirement readiness of employees of the employer. The plan health report 1202 is generated by determining retirement readiness of employees at step 1204, which may be used to generated individual retirement readiness reports 1210, and grouping employees at step 1212 so that the plan health report 1202 can convey retirement readiness according to the groupings.

At step 1204, retirement readiness is determined based on employee information 1206, such as age, current account balance, current deferral, and other information described above with respect to FIG. 4, and on plan parameters 1208, such as the rate of return of the retirement plan and the parameters of any company matching program. In some embodiments, retirement readiness is demonstrated by calculating for each employee a target replacement pay and an estimated retirement income from the retirement plan and other sources of retirement income such as Social Security. The target replacement pay is compared to the estimated retirement income to determine whether the employee's current deferral practices are exceeding, meeting, or falling short of the target. In some embodiments, a suggested deferral rate or amount, sufficient to meet the calculated target replacement pay, is calculated. The target replacement pay, estimated retirement income, estimated income from the retirement plan, estimated retirement income from other sources, and/or suggested deferral may be included in individual retirement readiness reports 1210, which may be included with the plan health report 1202. In some embodiments, average retirement plan information is calculated at step 1204, such as average deferral rate and average retirement account balance.

At step 1212, employees are grouped to allow for retirement readiness to be conveyed according to the groupings in the plan health report 1202. In some embodiments, employees are grouped according to age. For example, employees may be grouped into the following selected age ranges: age 29 and under, ages 30-39, ages 40-49, ages 50-59, and age 60 and over. The plan health report 1202 may then convey retirement readiness of each selected age range. For example, the plan health report 1202 may include the percentage of participants in the retirement plan falling short of target who are age 60 and over. In some embodiments, employees are grouped according to current salary. In particular, employees may be grouped into sequential salary ranges to allow the plan health report 1202 to convey retirement readiness of each salary range. In some embodiments, employees are grouped according to target replacement pay as calculated at step 1204. In particular, employees may be grouped into sequential target replacement pay ranges to allow the plan health report 1202 to convey retirement readiness of each target replacement pay range. In some embodiments, employees are grouped according to company division, allowing the plan health report 1202 to convey retirement readiness of each company division. The company division to which an employee belongs may be included in the employee information 1206. In some embodiments, employees are grouped according to the location to which they are assigned. In particular, employers may have multiple, geographically dispersed offices or other facilities, where employees are assigned to a specific office or facility. Employees may be grouped according to office or facility, city, state, or geographic region, allowing the plan health report 1202 to convey retirement readiness of each specified location. Location information for an employee may be included in the employee information 1206. Other information, such as participation and/or deferral rates, may be conveyed according to employee age or other groupings, as described above with respect to FIG. 10A.

The invention may be embodied in other specific forms without departing from the spirit or essential characteristics thereof. The foregoing embodiments are therefore to be considered in all respects illustrative, rather than limiting of the invention.

What is claimed is:

1. A system for providing a current status of a retirement plan of an employer, comprising
a server for
receiving a report request transmitted from a client operated by a user,
in response to the report request, generating a plan health report including the current status of the retirement plan based on employee information related to the retirement plan, wherein the current status of the retirement plan comprises information indicating retirement readiness of employees of the employer, and
transmitting the plan health report for receipt by the client; and
a database for storing the employee information related to the retirement plan.

2. The system of claim 1, wherein the employees are organized into groups according to the employee information and the plan health report indicates the current status of the retirement plan according to the groups.

3. The system of claim 2, wherein
the employee information includes age information indicating an age of at least one employee of the employer, and
the plan health report indicates the current status of the retirement plan for a plurality of age ranges.

4. The system of claim 3, wherein the plurality of age ranges includes at least one of 29 and under, 30-39, 40-49, 50-59, and 60 and over.

5. The system of claim 3, wherein the plan health report indicates retirement readiness of employees of a selected age range.

6. The system of claim 1, wherein
the server generates an average deferral rate of the retirement plan, and
the plan health report includes the average deferral rate and a comparable average deferral rate.

7. The system of claim 1, wherein
the server generates an average participation rate of the retirement plan, and
the plan health report includes the average participation rate and a comparable average participation rate.

8. The system of claim 1, wherein the server comprises
a proxy server for receiving the report request and transmitting the plan health report, and
an application server for generating the plan health report.

9. The system of claim 1, wherein
the report request indicates a request for individual reports, and
the server generates an individual report including information indicating retirement readiness of an individual employee of the employer.

10. The system of claim 1, wherein the employee information includes, for each employee of the employer participating in the retirement plan, a deferral rate, an income, and a retirement plan account balance for the respective employee.

11. The system of claim 1, wherein the employee information includes, for each employee of the employer, an indication of whether the respective employee is eligible for the retirement plan.

12. The system of claim 1, wherein the retirement readiness indicated in the plan health report is determined based on a predetermined retirement age, inflation rate, and life expectancy.

13. The system of claim 1, wherein the retirement readiness indicated in the plan health report comprises a percentage of employees not meeting a retirement target.

14. The system of claim 1, wherein the retirement readiness indicated in the plan health report comprises a percentage of employees exceeding a retirement target.

15. The system of claim 1, wherein the report request comprises a spreadsheet of employee information related to the retirement plan, and the current status of the retirement plan is based on the employee information in the spreadsheet.

16. The system of claim 1, wherein the report request comprises at least one of a target replacement pay level, a rate of return of the retirement plan, and a company match representing contributions of the employer to retirement plan accounts.

17. A method for providing a current status of a retirement plan of an employer, comprising
receiving at a server a report request transmitted from a client operated by a user,
in response to receiving the report request, generating a plan health report including the current status of the retirement plan based on employee information related to the retirement plan, wherein the current status of the retirement plan comprises information indicating retirement readiness of employees of the employer,
transmitting the plan health report for receipt by the client, and
storing the employee information related to the retirement plan in a database.

18. The method of claim 1, wherein the employees are organized into groups according to the employee information and the plan health report indicates the current status of the retirement plan according to the groups.

19. The method of claim 18, wherein
the employee information includes age information indicating an age of at least one employee of the employer, and
the plan health report indicates the current status of the retirement plan for a plurality of age ranges.

20. The method of claim 19, wherein the plurality of age ranges includes at least one of 29 and under, 30-39, 40-49, 50-59, and 60 and over.

21. The method of claim 19, wherein the plan health report indicates retirement readiness of employees of a selected age range.

22. The method of claim 1, comprising generating an average deferral rate of the retirement plan, wherein the plan health report includes the average deferral rate and a comparable average deferral rate.

23. The method of claim 1, comprising generating an average participation rate of the retirement plan, wherein the plan health report includes the average participation rate and a comparable average participation rate.

24. The method of claim 1, wherein the report request indicates a request for individual reports, and comprising generating an individual report including information indicating retirement readiness of an individual employee of the employer.

25. The method of claim 1, wherein the employee information includes, for each employee of the employer participating in the retirement plan, a deferral rate, an income, and a retirement plan account balance for the respective employee.

26. The method of claim 1, wherein the employee information includes, for each employee of the employer, an indication of whether the respective employee is eligible for the retirement plan.

27. The method of claim 1, comprising determining the retirement readiness indicated in the plan health report based on a predetermined retirement age, inflation rate, and life expectancy.

28. The method of claim 1, wherein the retirement readiness indicated in the plan health report comprises a percentage of employees not meeting a retirement target.

29. The method of claim 1, wherein the retirement readiness indicated in the plan health report comprises a percentage of employees exceeding a retirement target.

30. The method of claim 1, wherein the report request comprises a spreadsheet of employee information related to the retirement plan, and the current status of the retirement plan is based on the employee information in the spreadsheet.

31. The method of claim 1, wherein the report request comprises at least one of a target replacement pay level, a rate of return of the retirement plan, and a company match representing contributions of the employer to retirement plan accounts.
